(19) United States
(12) Patent Application Publication
(10) Pub. No.: US 2013/0099005 A1
(43) Pub. Date: Apr. 25, 2013

(54) CREDITCARD SHIELD

(71) Applicant: Stanley E. Baran, (US)

(72) Inventor: Stanley E. Baran, (US)

(21) Appl. No.: 13/281,184

(22) Filed: Oct. 25, 2011

(51) Int. Cl. G06K 19/07

(52) U.S. Cl. 235/492

(57) ABSTRACT

A card shielding kit having a first shield and second shield adapted for surroundingly protecting information on a personal card carried in a cardholder. The first and second shields creating a shielded area to sandwich shield the personal card to prevent unauthorized access or erasure of such information. The kit may be used as an aftermarket product for adapting to a user's existing or new cardholder to protect the information from unauthorized access and may be moved to a different cardholder for reuse.

### FIELD OF THE INVENTION

The present invention relates generally to and protecting personal information stored on personal cards such as credit, insurance, membership and identification cards and the like.

### BACKGROUND OF THE INVENTION

Credit cards and other personal cards may have personal information stored on the card that is easily accessible by a reader, used to electronically read encoded information on such a card. This information may be encoded and stored on magnetic strips, radio frequency identification device memory (RFID) or other optical or electronic storage media on or integrated into the personal card. The cards, collectively referred to as personal cards, are for the user's convenience to access information for such uses as transactions concerning banking, health, membership or identification. These personal cards are stored and carried on the owner's person or purse in cardholder generally comprising a billfold, wallet, clutch purse, trifold or the like. The cardholder may have slots or pockets for holding the personal cards in a removable and accessible manner. The personal information on the personal cards is read from the card generally using a swipe or “no touch” reader at a point-of-sale terminal, or remotely by an antenna, hand held reader or similar information gathering device. The antenna or reader generally must be pointed at the first or second side of the personal card and not at an edge. This personal information may also be accessible while the personal card is stored in a wallet or billfold, to readers used for unauthorized “skimming” such information by people attempting identity theft or other improper purposes. Such a reader used for skimming may be hand held or portable.

Prior art disclosures for protecting such information on personal cards have included manufacturing shields from expensive materials including mesh, foil or composite sheets. Furthermore, prior art protective devices are integrated into holders, such as a billfold, requiring special pockets or sewn into the construction of such cardholders. Other card protective devices include separate cases or cumbersome enclosures for each card or radio signal blocking antennas to protect from external, improper access to the encoded data.

Accordingly there is a need for a credit card shield kit which is inexpensive, easy to use and adaptable to a variety of cardholders either new or existing and movable from one cardholder to another to provide a double sided sandwich shield zone to prevent unauthorized reading of information on the personal card.

### BRIEF SUMMARY OF ONE EMBODIMENT OF THE INVENTION

One embodiment of the present invention is directed to a kit comprising a pair of signal blocking shields each having a shape and size configured to fit into a cardholder such as a wallet and adapted to shield the information on the personal card from surreptitious data capture by persons having bad intent. The information on the personal card may be on or in a memory device which may comprise an RFID memory chip with antenna, optical or magnetic strip or other device for holding personal information on personal card. The cardholder shall be any existing or new personal carrying device such as billfold, trifold, card case wallet, clutch type purse or other such card carrying device. The kit may have a set of shields in an appropriate size to fit the user's existing or new cardholder. In a first embodiment, each shield may be substantially similar to the profile of a respective portion of a pocket in the folded wallet adjacent to the personal cards being protected. The shields are adapted to be used by insertion into this pocket such as a money pouch next to each outside wall. This positioning on either side of the personal cards provide a sandwiched shielding effect to protect the personal cards and the information contained thereon from unauthorized reading or access.

The kit may comprise a first shield and the second shield adapted to hold the information carrying personal cards sandwiched between the first shield and the second shield. The shields, sandwich shielding the personal cards, are further adapted to be removably inserted in pockets of the cardholder to shield the personal cards. Each of the first and second shields may have an outside and an inside. Advertising or logos may be printed on each of the sides of each shield.

The shield kit may further comprise an after-market wallet specific set of shields adapted to fit without tools or modification of the wallet. The wallet may be any variety or type of cardholder able to position the personal cards sandwiched between the shields in a carrying configuration. The shields may be made of a signal blocking material such as aluminum, stainless steel, copper, brass or other non-magnetic material.

The above description sets forth, rather broadly, the more important features of the present invention so that the detailed description of the preferred embodiment that follows may be better understood and contributions of the present invention to the art may be better appreciated. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE SEVERAL VIEWS OF THE DRAWING

FIG. 1 is a perspective view illustrating a first embodiment of the present invention in a billfold holder.

FIG. 2 is a top view of the first embodiment having personal cards contained within the billfold folded for carrying.

FIG. 3 is an end elevation view of the personal cards sandwich shielded by the first embodiment of FIG. 1.

FIG. 4 is a front plan view of the first embodiment.

FIG. 5 is a front plan view of a second embodiment with a clutch purse or wallet cardholder in an open configuration.

FIG. 6 is a front plan view of the second embodiment with the clutch purse or wallet cardholder in a carrying configuration.

FIG. 7 is a section view taken at approximately 7-7 of FIG. 6.

FIG. 8 is a perspective of a third embodiment with a trifold holder in an open configuration.

FIG. 9 is a perspective of the third embodiment with the trifold holder in a carrying configuration

### DETAILED DESCRIPTION OF THE INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

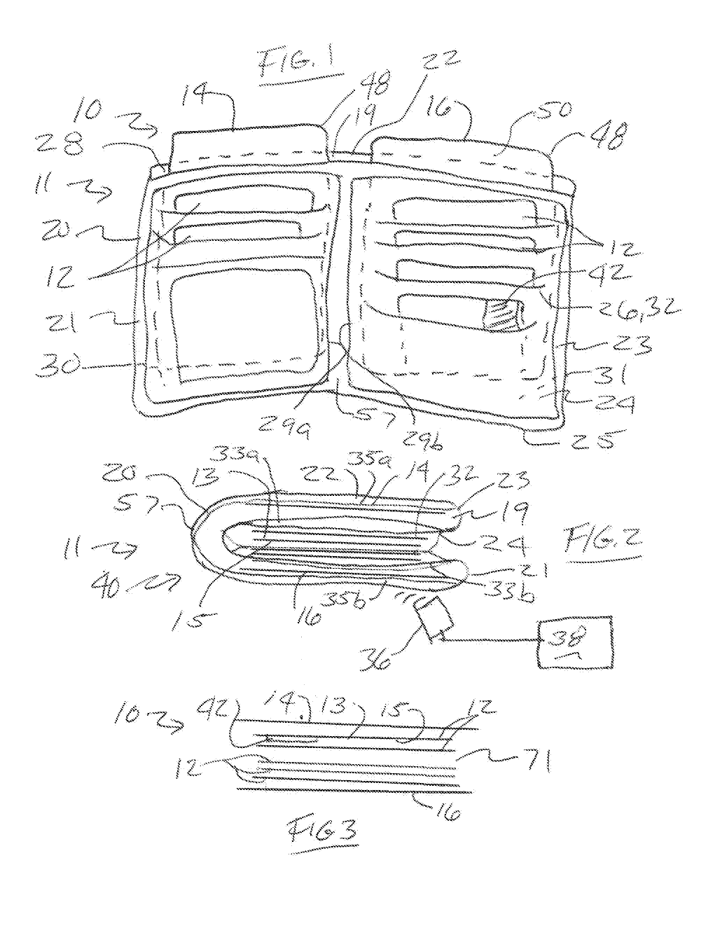

Referring to FIG. 1, the invention comprises a kit 10 adapted to be removably inserted into a cardholder 11 such as a billfold 20 to sandwich shield one or more personal cards 12 between a first billfold shield 14 in the second billfold shield 16 shown partially removed from billfold 20. Each billfold shield 14, 16 may have rounded corners 48, laminated sides and a signal blocking body 50. The billfold shields 14, 16 are removably disposed in billfold 20 adjacent to personal cards 12. The kit 10 may be adapted and applied as an aftermarket product to a variety of existing cardholders such as billfold 20. Billfold 20 may comprise an open top 19, outside 22 and an inside 24. The inside 24 may further comprise means 26 for holding personal cards 12 in readable configuration where each personal card 12 may be identified and removed individually. The outside 22 may be attached to the inside 24 at a first end 21 and second end 23 of the billfold 20 and along a bottom 25, forming an open pocket 28 between the inside 24 and the outside 22 which extends the entire length of the billfold 20. Paper money, receipts and other foldable items may be placed in the open pocket 28. The first end 21 has joined to the second end 23 by hinge 57. The first billfold shield 14 is configured to generally fit in a first portion 30 of the wallet 20 between hinge 57 and first end 21 and the second billfold shield 16 is similarly adapted to fit in the opposing portion 31 of the wallet 20 between hinge 57 and second end 23.

Continuing to refer to FIG. 1, the billfold 20 may have pockets positioned to hold the wallet shields 14, 16. Billfold 20 may have inside pockets 29a, 29b located behind the personal cards and accessible from the inside 24.

Referring to FIG. 2, the billfold 20 may comprise a plurality of personal card pockets 32 for holding each personal card 12 generally parallel to other personal cards 12 when the billfold 20 is in the carrying configuration 40. Each personal card 12 has a first side 13 and a second side 15. The first billfold shield 14 removably inserted adjacent the first side 13. The second billfold shield 16 removably inserted adjacent the second side 15 whereby the personal card 12 is between the first and second billfold shields 14, 16. The first and second billfold shields 14, 16 may be formed of a signal blocking design such as a plate, foil, screen, mesh or fabric to protect from inappropriate scanning by antenna 36 attached to a reader 38. In the folded or carrying configuration 40 of billfold 20 personal cards 12 are sandwich shielded between the first billfold shield 14 and second billfold shield 16.

Continuing to refer to FIG. 2, wallet may have hidden pockets 33a, 33b on inside 24, accessible from the open pocket 28 and generally aligned with inside pockets 29a, 29b. Alternatively, wallet may have a receipt pocket 35a, 35b attached to outside 22. Wallet shields 14, 16 may be removably inserted in the open pocket 28 at either end 21, 23, in inside pockets 29a, 29b, hidden pockets 33a, 33b or receipt pockets 35a, 35b. Opposing pockets are those that are on either side of the personal cards 12 in the carrying configuration 40. The first and second wallet shields 14, 16 may be removably inserted into any two opposing pockets to achieve the sandwich shielding of the personal cards 12 in the carrying configuration 40.

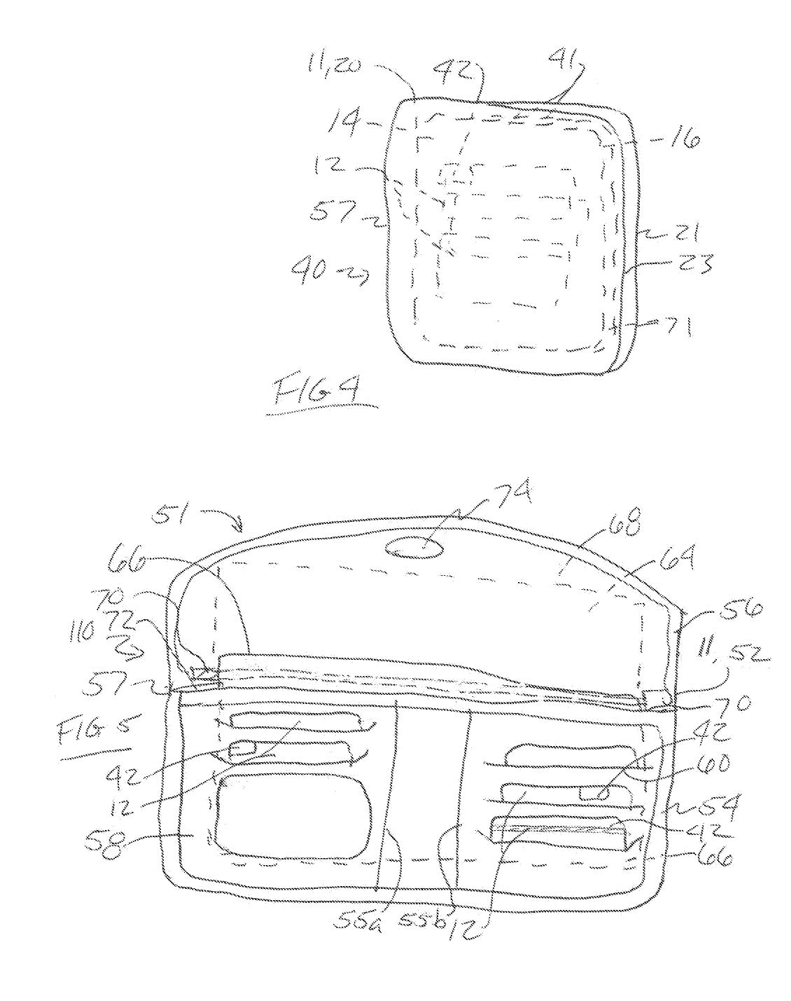

Referring to FIG. 3, the first shield 14 and second shield 16 are sized to shield a plurality of personal cards 12 positions in a stacked configuration in the billfold 20. Each personal card 12 may have electronically encoded information contained on or in a memory device 42 attached to or embedded in the personal card 12. In the closed or folded carrying configuration 40 (FIG. 2) the first and second shields 14, 16 and personal cards 12 are generally parallel to each other having the personal cards 12 between the first and second shields 12, 14 creating a double sided shield area 71 shielding the personal cards 12 from unauthorized reading of personal information on or in the card.

Referring to FIG. 4, first shield 14 is generally aligned and parallel with second shield 16 memory device 42 positioned inside the perimeter 41 of shields 14, 16 to prevent unauthorized reading of information thereon. The perimeter 41 of shields 14, 16 are generally aligned and in a parallel relationship configuration to form a shielded area 71 between the shields 14, 16 of sufficient size to shield all personal cards 12 in the cardholder and thereby sandwiched between shields 14, 16. The shields 14, 16 may be formed of a signal reflecting or blocking material and generally aligned in the card carrying configuration 40.

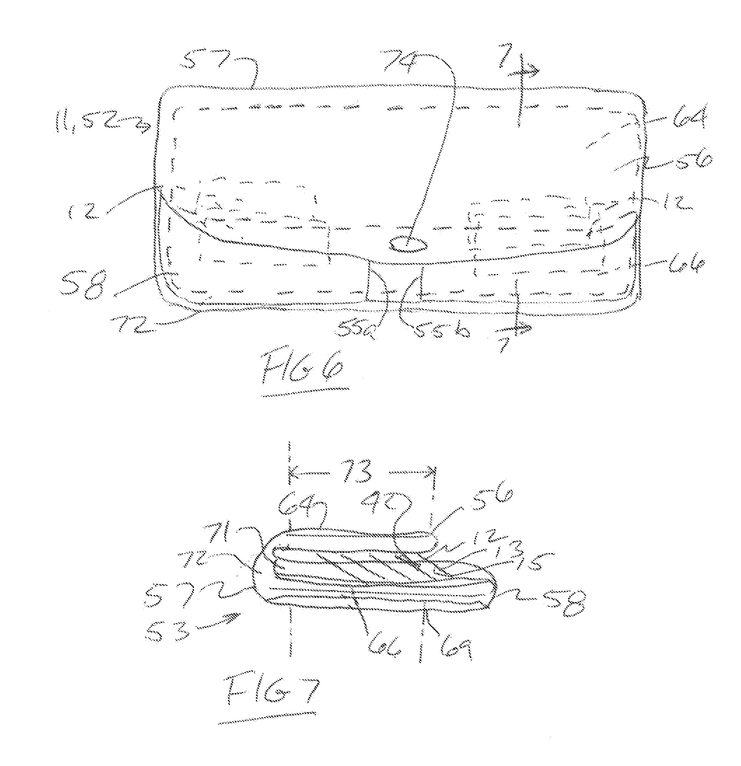

Referring to FIG. 5, kit 110 may comprise first wallet shield 64 and second wallet shield 66 adapted for use with a clutch purse or wallet cardholder 52 having a main body 54 and a closable flap 56, wallet cardholder 52 may have personal card holding pockets 60 adapted to hold personal cards 12 in a side-by-side stacked configuration. In an open configuration 51, closable flap 56 is pivoted away from front portion 58 about hinge 57 to provide access to personal cards 12. Front portion 58 on main body 54 is attached to closable flap 56 by hinge or gusset 57. Card pockets 60 may further be adapted for holding personal cards 12 in an offset configuration whereby each personal card may be identified by the user. First wallet shield 64 is removably inserted in flap pocket 68 in closable flap 56. Flap pocket 68 may have a zipper 70 or other closable means for retaining items including first wallet shield 64 in pocket 68. Second wallet shield 66 is adapted to be held in a paper money pocket 72 behind front portion 58.

Continuing to refer to FIG. 5, cardholder 52 may further comprise front pockets 55a, 55b located behind personal card pockets 60. It should be understood, that second wallet shield 66 may be replaced by shields similar to billfold shields 14, 16 removably inserted into front pockets 55a, 55b. Second wallet shield 66 may be adapted to removably insert in open pocket 72 behind front portion 58 and extending the entire length of wallet 52. Closing mechanism 74 may be used to attach the closable flap 56 to the main body 54. Closable flap 56 pivots along hinge or gusset 57 to an open configuration 51 to allow access to open pocket 72 and personal cards 12.

Referring to FIG. 6, the cardholder 11 shown as wallet 52 may be folded into a carrying configuration 53 having the closable flap 56 folded over front portion 58 thereby sandwich shielding the personal cards 12, specifically memory device 42 between the first wallet shield 64 in the closable flap 56 and the second wallet shield 66 in an opposing pocket behind the personal cards 12 in open pocket 72 or front pockets 55a, 55b. Personal cards 12 may be held in wallet 52 in a side-by-side and stacked configuration. First and second wallet shield 64, 66 are adapted to sandwich shield the personal cards 12 when the wallet is in the carrying configuration 53.

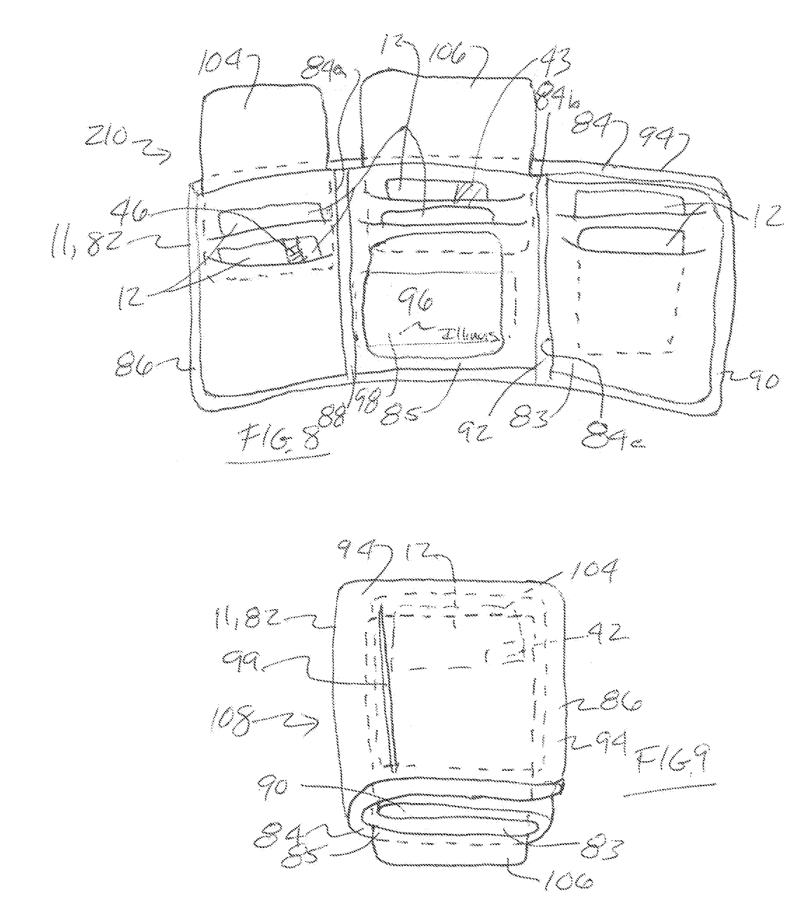

Referring to FIG. 7, closable flap 56 pivots along hinge or gusset 57 to carrying configuration 53 to cover front portion 58 and thereby position first wallet shield 64 in a generally parallel configuration to second wallet shield 66 having personal cards 12 held sandwich shielded by between wallet shields 64, 66. Second wallet shield 66 is between personal cards 12 and wallet back 69. The first wallet shield 64 removably inserted adjacent the first side 13. The second wallet shield 66 removably inserted adjacent the second side 15 whereby the personal card 12 is between the first and second billfold shields 64, 66. It should be understood, a shielding zone 73 is created where the shields overlap. The memory device 42 must be in the shielding zone 73 to be sandwich shielded.

Referring to FIG. 8, kit 210 may be adapted for use with a trifold 82 to provide sandwich shielding of personal cards 12. Trifold 82 may comprise a closing flap 86, center portion 85 and inside flap 90. Trifold may further comprise first gusset 88 connecting center portion 85 to closing flap 86. Inside flap 90 may be attached to center portion 85 by second gusset 92. Open pocket 84 may be formed between front 83 and back wall 94, and extending along the back wall 94 and extend from closing flap 86 to inside flap 90. Front pockets 84a, 84b, 84c behind personal cards 12 in closing flap 86, center portion 85 and inside flap 90 respectively may also retain either first trifold shield 104 or second trifold shield 106 provided the trifold 82 is closed to sandwich personal cards 12 between trifold shields 104, 106.

Continuing to refer to FIG. 8, memory device 42 may comprise an RFID memory chip 43 with antenna, or magnetic strip 46 holding personal information or other optical or electronic device on personal card 12. Center portion 85 may further comprise an identification window 96 adapted to hold an identification card 98 such as a drivers license, in a viewable position. In one embodiment, first trifold shield 104 may be adapted to fit into open pocket 84 in closing flap 86. First trifold shield 104 has a size generally similar to closing flap 86. Second trifold shield 106 may be inserted into open pocket 84 or 84b adjacent to and generally aligned with either center portion 85.

Referring to FIG. 9, trifold 82 may further comprise an outside pocket 99 usable for holding on of first and second trifold shields 104, 106. Trifold shields 104, 106 are sized and positioned to be on either side of personal cards 12 to sandwich shield when trifold 82 is folded into a carrying configuration 108. The trifold shields 104, 106 align with each other to sandwich shield personal cards 12, held in a stacked configuration in front 86. The trifold shields 104, 106 may be laminated in plastic to prevent damage to the card carrier a measure providing suitable writing surface for advertising, identification or similar printing. In the carrying configuration 108, personal cards 12 are sandwich shielded between trifold shields 104, 106 to protect from unauthorized scanning.

Referring to FIGS. 1-4, in use, a billfold 20 user removes the first billfold shield 14 and second billfold shield 16 from the kit 10 for insertion of each in a respective opposing pocket whereby personal cards 12 are sandwich shielded there between when the billfold 20 is folded into the carrying configuration 40. The shielding kit is provided having a first billfold shield 14 and a second billfold shield 16 and instructions describing a method of use. The billfold shields 14, 16 may be removably inserted in the user's billfold in any combination of pockets such that the personal cards 12 are sandwich shielded between the first shield 14 and the second shield 16 in a carrying configuration. The shields may be disposed in a separate pocket or positioned in an appropriate portion of the open pocket 28.

Referring to FIGS. 5-7, in use a wallet 52 user removes the first wallet shield 64 and second wallet shield 66 from kit 110. First wallet shield 64 is removably inserted into opposing pockets such as pocket 68 in closing flap 56. Second wallet shield 66 is removably inserted into main body 54 between personal cards 12 and wallet back 69. It should be understood, first and second wallet shields 64, 66 are generally parallel in the carrying configuration 53 and provide a double sided shielding zone 71 containing the personal cards 12 within the perimeter 73 to sandwich shield personal cards 12, especially memory devices 42.

Referring to FIGS. 8-9, in use a trifold 82 user removes first trifold shield 104 and second trifold shield 106 from kit 210. Locating two opposing pockets, one adjacent the first side 13 of personal cards 12 and the other adjacent second side 15, first trifold shield 104 is removably inserted between personal cards 12 and back wall 94. Second trifold shield is removably inserted in an opposing pocket adjacent the back wall having the personal cards 12 between first and second trifold shields 104, 106.

It should be understood, the size and configuration of kit may be chosen based on specific requirements of the cardholder, personal card types 12 or user specifications. The kit may be adapted for aftermarket use in a variety of cardholders. The size and shape of shields in the kit is determined by the type of cardholders to be used (billfold, trifold, wallet, etc). The kit may easily be removed from the cardholder for reuse in a new cardholder. Shields may be painted, laminated or coated with a plastic or paint type coating to resist corrosion, or have advertising or user identification information printed thereon.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given. Further, the present invention has been shown and described with reference to the foregoing exemplary embodiments. It is to be understood, however, that other forms, details, and embodiments may be made without departing from the spirit and scope of the invention which is defined in the following claims.

We claim:

1. A kit for sandwich shielding a first personal card in a cardholder, the cardholder having a pocket, a means for holding the personal card, and a carrying configuration, the personal card in the cardholder, the first personal card having a perimeter, a first side, a second side, and a memory device, the kit comprising:
a first signal blocking shield, the first signal blocking shield removably inserted in the cardholder adjacent the first side of the first personal card;
a second signal blocking shield removably inserted in the cardholder adjacent the second side, the first signal blocking shield disposed spaced from and in a substantially parallel orientation to the second signal blocking shield thereby forming a double sided shielding zone around the first personal card and between the first signal blocking shield and the second signal blocking shield in the carrying configuration whereby the memory device on the first personal card is sandwich shielded in the double sided shielding zone between the first signal blocking shield and the signal blocking second shield.

2. The invention of claim 1, further comprising a second personal card in the cardholder, the second personal card having a perimeter, a first side, a second side, and a memory device, the second personal card positioned having the memory device on the second card between the first signal blocking shield and the second signal blocking shield.

3. The invention of claim 2, wherein the cardholder is a billfold having a first end, a second end, a gusset, an inside and outside, the inside and the outside attached to form an open pocket extending along the length of the billfold, the first personal card adjacent the first end, the second personal card adjacent the second end and spaced from the first personal card in an open configuration of the billfold, the gusset between the first end and the second end and between the first personal card and the second personal card in the open configuration, the first signal blocking shield adapted to fit in the open pocket between the first end and the gusset, the signal blocking second shield spaced from the first signal blocking shield and adapted to fit in the open pocket between the second end and the gusset, whereby the memory devices on the first and second personal cards are sandwich shielded between the first signal blocking shield and the second signal blocking shield when the billfold is folded into the carrying configuration.

4. The invention of claim 1, wherein the cardholder is a wallet having a front portion, a hinge and a closable flap, the front portion connected to the closable flap by the hinge, the closable flap movable about the hinge to the carrying configuration, the front portion having a money pocket and a means for holding personal cards, the closable flap having a flap pocket, the first signal blocking shield disposed in the flap pocket, the second signal blocking shield disposed in the money pocket whereby the first signal blocking shield is spaced from the second signal blocking shield having the hinge therebetween and thereby creating a double sided sandwich shield around the personal cards and between the first signal blocking shield and the second signal blocking shield as the closable flap is pivoted about the hinge to the carrying configuration.

5. The invention of claim 2, wherein the cardholder is a trifold having a closing flap, a center portion and an inside flap, the closing flap pivotally connected to the center portion, the closing flap pivotally connected to the center portion and spaced from the inside flap, the trifold further comprising a back extending along and attached to each of the center portion, closing flap and inside flap to form an open pocket, the open pocket between the back and the personal cards, the first signal blocking shield in the open pocket adjacent to and aligned with one of the closing flap, a center portion or inside flap, the second signal blocking shield spaced from the first signal blocking shield, the second signal blocking shield in the open pocket adjacent to and aligned with another of the closing flap, center portion or inside flap whereby the memory devices on the personal cards are sandwich shielded between the first signal blocking shield and the second signal blocking shield when the closing flap, center portion and inside flap are pivoted into the carrying configuration.

6. The invention of claim 1, wherein the first signal blocking shield and second signal blocking shield are formed of metal.

7. The invention of claim 6, wherein the first signal blocking shield and second signal blocking shield are formed of aluminum.

8. The invention of claim 1, wherein the first signal blocking shield and second signal blocking shield are laminated.

9. The invention of claim 1, the cardholder further comprising a plurality of pockets having at least one of the plurality of pockets adjacent the first side of the personal card and at least one of the plurality of pockets adjacent the second side of the personal card, the first signal blocking shield adapted to fit in the at least one of the plurality of pockets adjacent the first side of the personal card, the second signal blocking shield adapted to fit in the at least one of the plurality of pockets adjacent the second side of the personal card whereby the double sided signal shielding zone shields the plurality of pockets.

10. The invention of claim 3, the personal cards in a stacked configuration having the first signal blocking shield substantially parallel to the second signal blocking shield thereby shielding the personal cards in the double sided shielding zone in the cardholder, the double sided shielding zone with the personal cards contained therein removable from the card holder while shielding the memory devices of the personal cards.

11. A kit for sandwich shielding a plurality of personal cards in a cardholder, the cardholder having an inside and an outside, each of the plurality of personal cards having a memory device, the kit comprising:
a first signal blocking shield removably inserted in cardholder between the outside and the plurality of personal cards, the first shield aligned with the personal cards, the first shield having a size generally larger than one of the personal cards;
a second signal blocking shield removably inserted in the cardholder between the personal cards and the outside, the second signal blocking shield spaced from the first shield, the second shield having a size generally similar to the first shield, whereby the first shield and second shield are substantially parallel having personal cards disposed between them.

12. (canceled)
